(19) United States
(12) Patent Application Publication
(10) Pub. No.: US 2013/0234080 A1
(43) Pub. Date: Sep. 12, 2013

(54) CONDUCTIVE PROTECTIVE FILM, TRANSFER MEMBER, PROCESS CARTRIDGE, AND IMAGE-FORMING APPARATUS

(71) Applicants: Kaoru TORIKOSHI, Kanagawa (JP); Kazunori ANAZAWA, Kanagawa (JP)

(72) Inventors: Kaoru TORIKOSHI, Kanagawa (JP); Kazunori ANAZAWA, Kanagawa (JP)

(73) Assignee: FUJI XEROX CO., LTD., Tokyo (JP)

(21) Appl. No.: 13/551,128

(22) Filed: Jul. 17, 2012

(30) Foreign Application Priority Data
Mar. 9, 2012 (JP) 2012-052438

(51) Int. Cl. H01B 1/20

(52) U.S. Cl. 252/519.31; 252/519.33; 252/519.34

(57) ABSTRACT

A conductive protective film has a surface layer including a resin and, as a conducting material, an inorganic metal oxide having a structural constitution or an inorganic metal oxide having an aspect ratio, which is a ratio between a short axis and a long axis, of approximately 10 or more.

### CROSS-REFERENCE TO RELATED APPLICATIONS

This application is based on and claims priority under 35 USC 119 from Japanese Patent Application No. 2012-052438 filed Mar. 9, 2012.

### BACKGROUND

1. Technical Field

The present invention relates to a conductive protective film, a transfer member, a process cartridge, and an image-forming apparatus.

2. Related Art

Currently, a method of visualizing image information through electrostatic charge images, such as electrophotography, is being used in a variety of fields. In electrophotography, a latent image (electrostatic latent image) is formed on an image holding member through charging and exposure processes (latent image-forming process), the electrostatic latent image is developed using an electrostatic charge image developer (hereinafter sometimes referred to simply as the “developing agent”) including an electrostatic charge image developing toner (hereinafter, sometimes, referred to simply as a “toner”) (developing process), and the developed electrostatic latent image is visualized through a transferring process and a fixing process.

A variety of transferring methods are employed in order to transfer toner images, and, for example, a corotron discharge method, a contact transfer method, and the like are known. As the contact transfer method, a method in which a polyurethane conductive roller, belt, or the like having conductive particles, such as carbon, dispersed therein is used has been developed.

### SUMMARY

According to an aspect of the invention, there is provided a conductive protective film including a resin and, as a conducting material, an inorganic metal oxide having a structural constitution or an inorganic metal oxide having an aspect ratio, which is a ratio between a short axis and a long axis, of approximately 10 or more.

### BRIEF DESCRIPTION OF THE DRAWINGS

Exemplary embodiments of the present invention will be described in detail based on the following figures, wherein:

FIG. 1 is a schematic configuration view showing an example of an image-forming apparatus according to an exemplary embodiment of the invention.

### DETAILED DESCRIPTION

An exemplary embodiment of the invention will be described. The exemplary embodiment is an example for carrying out the invention, and the invention is not limited to the exemplary embodiment.

<Conductive Protective Film>

A conductive protective film according to the exemplary embodiment of the invention includes a resin and, as a conducting material, an inorganic metal oxide having a structural constitution or an inorganic metal oxide having an aspect ratio, which is a ratio between a short axis and a long axis, of 10 or more (or approximately 10 or more).

In the conductive protective film according to the exemplary embodiment of the invention, the inorganic metal oxide as a conducting material exhibits conductivity through approach or contact of the base material in the resin according to the percolation theory. In exhibiting the conductivity, the amount of the conductive material added to the resin or the dispersion state of the conductive material is a significant element, but the present inventors have found that, not only the primary structure of the inorganic metal oxide, but also the higher-order structure (a structural constitution or an aspect ratio (the ratio between the short axis and the long axis)) in which the inorganic metal oxides are combined, which has been rarely reported in the related art, plays a significant role for conductivity exhibition, and control of the higher-order structure is significant for control of the conductivity in the resin. A conductive protective film having stabilized resistance control and discharge degradation resistance may be obtained by containing, as a conductive material, an inorganic metal oxide having the structural constitution or an inorganic metal oxide having an aspect ratio, which is the ratio between the short axis and the long axis, of 10 or more in the conductive protective film. Since the inorganic metal oxide having the structural constitution or the inorganic metal oxide having an aspect ratio, which is the ratio between the short axis and the long axis, of 10 or more has surface resistivity that changes slightly even when the content of the conductive protective film in the resin changes, the resistance changes slightly due to variation in the dispersion state of the inorganic metal oxide in the resin, variation in the in-plane distribution, and the like, the resistance control stability is excellent, and discharge degradation is suppressed.

Here, the “structural constitution” of the inorganic metal oxide in the present specification refers to a structure in which primary particles are connected with each other, and specifically refers to a state in which the values of particle diameters which are analyzed through electron microscope observation become larger than primary particles. When the values of particle diameters are less than 2, resistance controllability is lacking, and, when the values exceed 40, variation in dispersion stability or resistance is caused.

The “aspect ratio” refers to a ratio between the short axis and the long axis of an acicular particle, and, specifically, is measured through electron microscope observation. In the exemplary embodiment, the aspect ratio of the inorganic metal oxide is 10 or more, and preferably in a range of from 15 to 50. When the aspect ratio of the inorganic metal oxide is less than 10, the effect of resistance control is small, and, when the aspect ratio of the inorganic metal oxide exceeds 50, there are cases in which the resistance becomes too low.

The inorganic metal oxide having the structural constitution is obtained by, for example, a flame method. In addition, the inorganic metal oxide of which the aspect ratio, which is a ratio between the short axis and the long axis, is 10 or more is obtained by, for example, a sol-gel method.

In the exemplary embodiment, the content of the inorganic metal oxide with respect to the weight of the resin is preferably in a range of from 10% by volume to 40% by volume (or from approximately 10% by volume to approximately 40% by volume), and more preferably in a range of from 15% by volume to 30% by volume. When the content of the inorganic metal oxide is less than 10% by volume, there are cases in which desired conductivity may not be obtained, and, when the content exceeds 40% by volume, there are cases in which the film strength is influenced.

The surface resistivity of the surface layer is preferably in a range of from 1×10⁸Ω/□ to 1×10¹⁴Ω/□ (or from approximately 1×10⁸Ω/□ to approximately 1×10¹⁴Ω/□), and more preferably in a range of from 1×10⁹Ω/□ to 1×10¹³Ω/□. When the surface resistivity of the surface layer is less than 10⁸Ω/□, there are cases in which electric currents leak, and, when the surface resistivity exceeds 10¹⁴Ω/□, there are cases in which electrostatic transfer is not possible.

The surface resistivity is measured using an ADVANTEST R8340A ULTRA HIGH RESISTANCE METER and a UR probe of Mitsubishi Chemical Analytech Co., Ltd. as the probe.

In the conductive protective film according to the exemplary embodiment, by using the inorganic metal oxide having the structural constitution or the inorganic metal oxide having an aspect ratio, which is a ratio between the short axis and the long axis, of 10 or more, the surface resistivity of from 10⁸Ω/□ to 10¹⁴Ω/□ is achieved with a content of from 10% by volume to 40% by volume, which is smaller than that in the inorganic metal oxide of the related art.

The inorganic metal oxide includes metal oxides, such as ZnO, ZnSnO₃, Zn₂SnO₄, TiO, TiO₂, SnO₂, Al₂O₃, In₂O₃, SiO, SiO₂, MgO, BaO, MoO₃, and the like. In addition, the metal oxide may be a metal oxide further containing heterogeneous elements, and examples thereof include metal oxides containing (being doped with) Al, In, and the like in ZnO; Nb, Ta, and the like in TiO₂; and Sb, Nb, halogen elements, and the like in SnO₂. In terms of resistance controllability, metal oxides having Sb doped in TiO₂ or SnO₂ are preferable. The inorganic metal oxide may be used singly, or two or more thereof may be jointly used.

The resin is not particularly limited, and includes a urethane resin, a polyimide resin, a polyamideimide resin, a polyester resin, a polyamide resin, a fluororesin, and the like. Examples of the urethane resin include urethane resins formed by polymerizing a hydroxyl group-containing acrylic resin containing a hydroxyl group and an isocyanate.

The resin is preferably a urethane resin that is formed by polymerization of: a hydroxyl group-containing acrylic resin in which a content ratio (molar ratio) of side chain hydroxyl groups having 10 or more carbon atoms to side chain hydroxyl group having less than 10 carbon atoms is less than 1/3 (or approximately less than 1/3) (including a case in which no side chain hydroxyl groups having 10 or more carbon atoms are included); a polyol having plural hydroxyl groups in which the hydroxyl groups are coupled through a carbon chain having 6 or more carbon atoms; and an isocyanate, in which a ratio (B/A) of a total molar amount (B) of the hydroxyl groups included in the polyol to a total molar amount (A) of the hydroxyl groups included in the acrylic resin is from 0.1 to 10 (or from approximately 0.1 to approximately 10).

By using the above urethane resin for a surface layer, a conductive protective film that is highly resistant to discharge degradation and has self-restorability is obtained, and transferability to paper having large recesses and protrusions on the surface (embossed paper, crocodile or lezak paper, and the like) is excellent. In addition, by including at least one of a silicon atom and a fluorine atom, the urethane resin imparts mold-releasing properties to a high crosslink density self-restoring material that is resistant to damage and particularly to discharge degradation. Here, the “paper having large recesses and protrusions on the surface” refers to paper of which the surface roughness measured using a surface roughness meter is 5 or more.

Meanwhile, a side chain having 10 or more carbon atoms is defined to be a long side chain, and a side chain having less than 10 carbon atoms is defined to be a short side chain. The number of carbon atoms in the long side chain is preferably 15 or more, and more preferably 20 to 60. The number of carbon atoms in the short side chain is preferably 6 or less, and more preferably 2 to 4. In addition, the long side chain preferably includes an opened ε-lactone ring which is a structure with which particularly elasticity is easily enhanced.

By employing the above configuration, the urethane resin becomes excellent in terms of self restorability compared to a urethane resin in which the proportion of the long side chain hydroxyl groups is outside the above range. Since the self restorability is excellent, the urethane resin works excellently with respect to embossed paper and the like. The reason why the self restorability is excellent is not clear, but is assumed as follows.

In a polymer included in the urethane resin, the side chain hydroxyl groups of the hydroxyl group-containing acrylic resin and isocyanate combine with each other so as to form a crosslinked structure, and it is considered that the self restorability is exhibited due to the crosslinked structure. Specifically, it is considered that, for example, when strong impacts are partially caused on the surface of a resin material, the urethane resin does not immediately rebound, flexibly bends once so as to weaken the impacts, and then restores (so-called self-restores) so as to return to the original state, thereby realizing self restorability (a property of restoring damage once caused).

In addition, it is considered that, in the exemplary embodiment, by using particularly the hydroxyl group-containing acrylic resin in which the proportion of the long side chain hydroxyl groups is in the above range, variation in the length of the side chains in the acrylic resin is small, and, due to favorable compatibility of the acrylic resin and the isocyanate, the respective components included in the composition are not easily unevenly distributed even during polymerization, and are polymerized in a state of being evenly distributed.

For example, in the polymer in which the uneven distribution is caused during polymerization, it is considered that weak elasticity locations are partially caused, and consequently, it becomes difficult to obtain restorability of damage in the resin material. In contrast to the above, in the exemplary embodiment, since it is considered that the components are evenly polymerized, and self-restorability is exhibited across the entire resin material, it is assumed that restorability of damage improves in the resin material compared to a form in which the uneven distribution is easily caused.

In addition, in the exemplary embodiment, since the compatibility of the acrylic resin and the isocyanate is favorable in the composition as described above, it is considered that the transparency is high, and rough surfaces are suppressed particularly in a case in which the resin material is in a film shape.

In the exemplary embodiment, the polymer may have at least one of a fluorine atom and a silicon atom. A urethane bond generated by combining an OH group in the acrylic resin and the isocyanate is hydrophilic, and a fluorine atom and a silicon atom are hydrophobic. Therefore, it is considered that the compatibility of the acrylic resin and the isocyanate degrades due to the presence of at least one of a fluorine atom and a silicon atom. However, in the exemplary embodiment, the proportion of the long side chain hydroxyl groups is in the above range as described above. Therefore, it is considered that, even in a case in which the polymer has at least one of a fluorine atom and a silicon atom, compared to a case in which the proportion of the long side chain hydroxyl group is outside the above range, the compatibility between the acrylic resin and the isocyanate is favorable, and restorability of damage becomes favorable. In addition, the surface layer has excellent mold-releasing properties due to the polymer having at least one of a fluorine atom and a silicon atom.

As to the polymer having at least one of a fluorine atom and a silicon atom, at least one of a fluorine atom and a silicon atom may be included in at least any of the hydroxyl group-containing acrylic resin, the isocyanate, and other components (that is, components other than the hydroxyl group-containing acrylic resin and the isocyanate) which are included in the composition. Among the above, the hydroxyl group-containing acrylic resin having at least one of a fluorine atom and a silicon atom is preferable. Specifically, examples thereof include the hydroxyl group-containing acrylic resin having a side chain including at least one of a fluorine atom and a silicon atom. In addition, the polymer may have only one of a fluorine atom and a silicon atom, or may have both of a fluorine atom and a silicon atom.

<Return Rate>

The self restorability is represented by, for example, a return rate. That is, the return rate is an index that represents the self restorability (a property of restoring strains caused by a stress when the stress is removed, that is, the degree of damage restoration) of a resin material. The return rate is measured using, for example, a FISCHERSCOPE HM2000 (manufactured by Fischer Instruments K.K.) as a measurement apparatus. Specifically, for example, a sample resin layer is obtained by coating and polymerizing a composition including the hydroxyl group-containing acrylic resin and the isocyanate on a polyimide film. In addition, the obtained sample resin layer is fixed on a glass slide using an adhesive, and set in the measurement apparatus. A load is applied to the sample resin layer at room temperature (23° C.) up to 0.5 mN for 15 seconds, and maintained at 0.5 mN for 5 seconds. The maximum displacement at this time is represented as (h1). After that, the load is reduced to 0.005 mN, and maintained at 0.005 mN for 1 minute. The displacement at this time is represented as (h2), and a return rate [(h1−h2)/h1] is computed.

The return rate of the urethane resin according to the exemplary embodiment at 23° C. is preferably from 80% to 100%, and more preferably from 90% to 100%. Meanwhile, the return rate is an index that represents the damage restorability (the degree of restorability of damage caused by an external force) of the high crosslinked urethane resin. When the return rate is less than 80% at 23° C., the damage restorability is not easily exhibited under the environment at an operation temperature.

Meanwhile, as described above, the resin material according to the exemplary embodiment is polymerized at a polymerization ratio at which the ratio (B/A) of the total molar amount (B) of the hydroxyl groups included in all the polyols that are used for polymerization to the total molar amount (A) of the hydroxyl groups included in all the hydroxyl group-containing acrylic resins that are used for polymerization becomes from 0.1 to 10. That is, the polymerization is carried out while the polymerization ratio between the hydroxyl group-containing acrylic resins and the polyols is controlled according to the molar amount of the hydroxyl groups included in the hydroxyl group-containing acrylic resin and the molar amount of the hydroxyl group included in the polyols so that the ratio (B/A) falls in the above range.

Meanwhile, the return rate is adjusted by controlling the amount of the long side chain hydroxyl groups, the amount of the short side chain hydroxyl groups, the amount of the long chain polyol, the length of the chain of the long chain polyol, the kind of a crosslinking agent, and the like. That is, the return rate has a tendency of increasing as the amount of the long side chain hydroxyl groups increases, and the amount of the long chain polyol increases. On the other hand, the return rate has a tendency of decreasing as the added amount of the long chain polyol decreases.

However, when the added amount of the long side chain hydroxyl groups or long chain polyol is too large with respect to the amount of the short side chain hydroxyl groups, there are cases in which discharge degradation resistance (an increase in the surface resistivity through a discharge degradation test) deteriorates.

Next, the composition of the resin material according to the exemplary embodiment will be described.

<Hydroxyl Group-Containing Acrylic Resin>

In the exemplary embodiment, the hydroxyl group-containing acrylic resin is an acrylic resin that has a side chain hydroxyl group having less than 10 carbon atoms (the short side chain hydroxyl group) and does not have a side chain hydroxyl group having 10 or more carbon atoms (the long side chain hydroxyl group) or an acrylic resin for which the content ratio (molar ratio) of the long side chain hydroxyl groups to the short side chain hydroxyl group is less than 1/3.

Examples of a monomer having a hydroxyl group include ethylenic monomers having a hydroxyl group, such as hydroxymethyl(meth)acrylate, hydroxyethyl(meth)acrylate, hydroxypropyl(meth)acrylate, hydroxybutyl(meth)acrylate, and N-methylol acrylamine, and the like. The monomer having a hydroxyl group may be used singly or in two or more kinds. Examples of a monomer having a carboxyl group include (meth)acrylic acid, crotonic acid, itaconic acid, fumaric acid, maleic acid, and the like. The monomer having a carboxyl group may be used singly or in two or more kinds.

In addition, examples of a monomer including the long side chain hydroxyl group include monomers having the hydroxyl group, monomers formed by adding ε-caprolactone to the monomer having a carboxyl group, monomers formed by adding a diol compound having 6 or more carbon atoms thereto, and the like. Specific examples include monomers having ε-caprolactone added to 1 mole of hydroxymethyl(meth)acrylate in a range of from 1 mole to 10 moles, monomers having hexanediol, heptanediol, octanediol, nonanediol, or decanediol added thereto, and the like. The monomer including the long side chain hydroxyl group may be used singly or in two or more kinds; however, when one kind of the monomer is used, the hydroxyl group-containing acrylic resin having uniform lengths of side chains is easily obtained.

Examples of a monomer having no hydroxyl group include (meth)acrylate alkyl esters, such as methyl(meth)acrylate, ethyl(meth)acrylate, propyl(meth)acrylate, butyl(meth)acrylate, n-propyl(meth)acrylate, n-butyl(meth)acrylate, isobutyl(meth)acrylate, 2-ethylhexyl(meth)acrylate, n-octyl(meth)acrylate, and n-dodecyl(meth)acrylate, and the like, and are not particularly limited as long as the monomer is an ethylenic monomer that copolymerizes with the monomer having a hydroxyl group. The monomer may be used singly or in two or more kinds.

The acrylic resin having a side chain including a fluorine atom is obtained by, for example, using a monomer including a fluorine atom. The monomer including a fluorine atom is not particularly limited, and examples thereof include monomers having from 2 to 20 carbon atoms in the side chain including a fluorine atom. In addition, the number of fluorine atoms included in one molecule of the monomer including fluorine atoms is not particularly limited, and examples thereof include from 1 to 25, and may be from 9 to 17. Specific examples of the monomer including fluorine atoms include hexafluoro-2-propyl acrylate, 2-(perfluorobutyl)ethyl acrylate, 2-(perfluorohexyl)ethyl acrylate, hexafluoro-2-propyl methacrylate, 2-(perfluorohexyl)ethyl methacrylate, perfluorohexyl ethylene, and the like, and the monomer may be used singly or in two or more kinds.

The acrylic resin having a side chain including a silicon atom is obtained by, for example, using a monomer including a silicon atom. The monomer including a silicon atom is not particularly limited, and examples thereof include monomers including a siloxane bond. Specific examples include silicone represented by the formula (A).

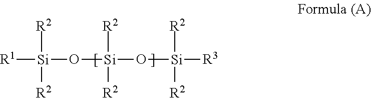

In the formula (A), R¹ represents an alkyl group having from 1 to 10 carbon atoms, an amino group, a hydroxyl group, a methoxy group, an ethoxy group, an alkylamino group having from 1 to 10 carbon atoms, an aminoalkyl group having from 1 to 10 carbon atoms, a hydroxyalkyl group having from 1 to 10 carbon atoms, an alkoxy group having from 1 to 10 carbon atoms, a methoxyalkyl group having from 1 to 10 carbon atoms, an ethoxyalkyl group having from 1 to 10 carbon atoms, an alkyl methacrylate group having from 1 to 10 carbon atoms, or an alkyl acrylate group having from 1 to 10 carbon atoms, R² represents a methyl group, a phenyl group, or an ethyl group, and R³ represents an alkyl methacrylate group having from 1 to 10 carbon atoms or an alkyl acrylate group having from 1 to 10 carbon atoms. Meanwhile, in the formula (A), the number (n) of groups in the parentheses in —[Si(R²)₂—]— is not particularly limited, and examples thereof include from 3 to 1,000.

Examples of a number average molecular weight of the monomer including a siloxane bond include from 250 to 50,000, and may be from 500 to 20,000.

Specific examples of the monomer including a siloxane bond include SILAPLANE FM-0701, FM-0711, FM-0721, FM-0725 (all manufactured by JNP Co., Ltd.) and the like.

The hydroxyl group-containing acrylic resin including both a fluorine atom and a silicon atom is obtained by, for example, using both the monomer including a fluorine atom and the monomer including a silicon atom. Examples of the hydroxyl group-containing acrylic resin including both a fluorine atom and a silicon atom include hydroxyl group-containing acrylic resins obtained using the monomer including a fluorine atom and the monomer including a siloxane bond.

In the exemplary embodiment, the hydroxyl group-containing acrylic resin is synthesized by, for example, mixing the monomers, radically or ionically polymerizing the mixed monomers, and then purifying the resultant.

The hydroxyl group-containing acrylic resin that is used in the exemplary embodiment may be only one kind or two or more kinds.

In a case in which the hydroxyl group-containing acrylic resin has a side chain including a fluorine atom, examples of a proportion of the side chains including a fluorine atom to all the side chains include from 1 mol % to 70 mol %, and may be from 5 mol % to 50 mol %.

In a case in which the hydroxyl group-containing acrylic resin has side chains including a silicon atom, examples of a proportion of the monomers including a silicon atom to all the monomers that are used for synthesis of the hydroxyl group-containing acrylic resin include from 5% by weight to 50% by weight, and may be from 10% by weight to 30% by weight.

<Isocyanate>

In a case in which the hydroxyl group-containing acrylic resins or long chain polyols described below are used, the isocyanate functions as a crosslinking agent that crosslinks the hydroxyl group-containing acrylic resin and the long chain polyol or the long chain polyols.

The isocyanate is not particularly limited, and specific examples thereof include methylene diisocyanate, toluene diisocyanate, hexamethylene diisocyanate, isophorone diisocyanate, and the like. The isocyanate may be only one kind or two or more kinds.

Meanwhile, the content of the isocyanate includes from 0.5 time to 3 times with respect to the molar number (the total molar number of the hydroxyl group-containing acrylic resin and the hydroxyl groups in the polyols in a case in which the long chain polyols are used) of the hydroxyl group in the hydroxyl group-containing acrylic resin in terms of the molar number of the isocyanate groups.

<Long Chain Polyol>

In the exemplary embodiment, the composition may include the long chain polyols as necessary. The long chain polyol is a polyol having plural hydroxyl groups in which all of the hydroxyl groups are bonded with each other through chains having 6 or more carbon atoms (the number of carbon atoms in a portion of a straight chain that bonds the hydroxyl groups).

The long chain polyol is not particularly limited, and examples thereof include bifunctional polycaprolactone diols, such as compounds represented by the following formula (1), trifunctional polycaprolactone triols, such as compounds represented by the following formula (2), other tetrafunctional polycaprolactone polyols, and the like. The long chain polyol may be only one kind or two or more kinds.

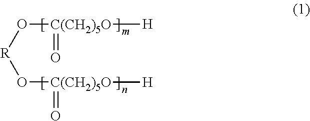

(In the formula (1), R is any one of C₂H₄, C₂H₄OC₂H₄, and C(CH₃)₂(CH₂)₂, and m and n are an integer of from 4 to 35.)

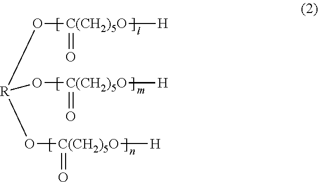

(In the formula (2), R is any one of CH₂CHCH₂, CH₃C(CH₂)₂, and CH₃CH₂C(CH₂)₃, and (1+m+n) is an integer of from 3 to 30.)

The long chain polyol may include a fluorine atom. Examples of the long chain polyol including a fluorine atom include 1H,1H,9H,9H-perfluoro-1,9-nonanediol, tetraethylene glycol fluoride, 1H,1H,8H,8H-perfluoro-1,8-octanediol, and the like.

Examples of the number of functional groups in the long chain polyol (that is, the number of hydroxyl groups included in one molecule of the long chain polyol) include a range of from 2 to 5, and may be from 2 to 3.

As the added amount of the long chain polyol, examples of the ratio (B)/(A) of the total molar amount (B) of the hydroxyl groups included in all the long chain polyols that are used for polymerization to the total molar amount (A) of the hydroxyl groups included in all the hydroxyl group-containing acrylic resins that are used for polymerization include a range of from 0.1 to 10, and may be from 1 to 4.

<Compounds Including a Silicon Atom>

In the exemplary embodiment, the composition may contain a compound including a silicon atom as necessary.

Examples of the compound including a silicon atom include compounds having a substituent that reacts with the isocyanate, and specific examples thereof include compounds having at least one kind selected from an amino group, a hydroxyl group, a methoxy group, and an ethoxy group.

In addition, the compound including a silicon atom is not particularly limited as long as the compound includes a silicon atom, and examples thereof include compounds including a siloxane bond. Specific examples thereof include silicones represented by the formula (B)

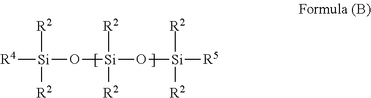

In the formula (B), R⁴ and R⁵ each independently represent an alkyl group having from 1 to 10 carbon atoms, an amino group, a hydroxyl group, a methoxy group, an ethoxy group, an alkylamino group having from 1 to 10 carbon atoms, an aminoalkyl group having from 1 to 10 carbon atoms, a hydroxyalkyl group having from 1 to 10 carbon atoms, an alkoxy group having from 1 to 10 carbon atoms, a methoxy alkyl group having from 1 to 10 carbon atoms, an ethoxyalkyl group having from 1 to 10 carbon atoms, an alkyl methacrylate group having from 1 to 10 carbon atoms, or an alkyl acrylate group having from 1 to 10 carbon atoms, and R² is the same as in R² in the formula (A). In addition, in the formula (B), the number (n) of groups in the parenthesis in —[Si (R²)₂—O]— is not particularly limited, and examples thereof include from 3 to 1,000.

Meanwhile, R⁴ and R⁵ may be the same or different from, and at least one of R⁴ and R⁵ preferably has at least one kind selected from an amino group, a hydroxyl group, a methoxy group, and an ethoxy group.

Examples of a weight average molecular weight of the compound including a siloxane bond include from 250 to 50,000, and may be from 500 to 20,000.

Specific examples of the compound including a siloxane bond include KF9701, KF8008, KF8010, KF6001 (manufactured by Shin-Etsu Chemical Co., Ltd.), TSR160, TSR145, TSR165, YF3804 (manufactured by Momentive Performance Materials Inc.), and the like.

Examples of the added amount of the compound including a siloxane bond include from 1% by weight to 60% by weight of the entire composition, and may be from 2% by weight to 40% by weight or from 5% by weight to 30% by weight.

<Polymerization Method>

Next, a method of forming the resin material according to the exemplary embodiment (method of polymerizing the composition) will be described.

Firstly, as an example of a method of forming a resin material, a method of forming a resin layer sample in which a resin material is formed on a polyimide film will be described. Specifically, for example, the hydroxyl group-containing acrylic resin, the isocyanate, and, if necessary, the long chain polyol are mixed so as to prepare a composition. Next, after the composition is defoamed under depressurization, the composition is coated (cast) on, for example, a 90 μm polyimide film. After that, the polyimide film on which the composition has been coated is heated, for example, at 85° C. for 60 minutes and at 160° C. for 1 hour so as to be cured, thereby obtaining a resin material including a polymer of the composition.

Meanwhile, the base material on which the composition is coated in actual use is not limited to the polyimide film, and a member having a surface to be protected may be used.

Examples of a method of confirming whether or not the polymer included in the resin material obtained in the above manner is a polymer of the composition containing the acrylic resin in which the proportion of the long side chain hydroxyl group is in the above range and the isocyanate include the following method. Specific examples thereof include a method in which the obtained resin material is analyzed through thermal decomposition gas chromatography mass spectrometry (thermal decomposition GC-MS). That is, the acrylic resin is decomposed into monomer units by thermally decomposing the obtained resin material. In addition, the structure and proportion of monomers that are used for synthesis of the acrylic resin are determined through the mass spectrometry of the decomposition product obtained by decomposition, and the proportion of the long side chain hydroxyl group is obtained.

The conductive protective film according to the exemplary embodiment of the invention is preferably used for a transfer member. The transfer member generally has the conductive protective film according to the exemplary embodiment as a surface layer on a base material.

A material that is used for the base material of the transfer member according to the exemplary embodiment includes a polyimide-based resin, a polyamideimide-based resin, a polyester-based resin, a polyamide-based resin, a fluorine-based resin, and the like, and, among them, a polyimide-based resin and a polyamideimide-based resin are more preferably used.

In a case in which the transfer member according to the exemplary embodiment is a belt-shaped transfer member, the base material may have or not have a joint as long as the base material has a ring shape (an endless shape). In addition, the thickness of the base material is, for example, in a range of from 0.02 mm to 0.2 mm. The belt-shaped transfer member has the ring-shaped (endless shaped) base material and a surface layer laminated on the surface of the base material. The thickness of the surface layer is, for example, in a range of from 5 μm to 500 μm.

In a case in which the transfer member according to the exemplary embodiment is a roll-shaped transfer member, the base material may have a cylindrical shape. In addition, the thickness of the base material is, for example, in a range of from 0.2 mm to 1 mm. The roll-shaped transfer member has the cylindrical base material and a surface layer laminated on the surface of the base material. The thickness of the surface layer is, for example, in a range of from 5 μm to 500 μm.

The dynamic contact angle (advancing contact angle) of the surface layer of the transfer member according to the exemplary embodiment is preferably in a range of from 80 degrees to 150 degrees, and more preferably from 90 degrees to 110 degrees. When the dynamic contact angle (advancing contact angle) is 60 degrees or more, excellent mold-releasing properties may be obtained.

Meanwhile, the dynamic contact angle is adjusted by controlling the amount of fluorine atoms, the amount of silicon atoms, and the like which are included in the hydroxyl group-containing acrylic resin and the long chain polyol.

The dynamic contact angle (advancing contact angle) is obtained by dropping water droplets on the solid surface of the resin material using an injector, further injecting water into the droplets so as to expand the droplets, and measuring a contact angle at an instance when the contact surface between the resin material and water increases as the dynamic (advancing) contact angle. In addition, a retreating contact angle is obtained by sucking water in the water droplets after measuring the advancing contact angle and measuring a contact angle immediately before the contact surface between the resin material and water decreases as the retreating contact angle. Meanwhile, the contact angle is measured at room temperature (25° C.) using a FACE Contact Angle Meter (manufactured by Kyowa Interface Science Co., Ltd.).

<Process Cartridge and Image-Forming Apparatus>

The image-forming apparatus according to the exemplary embodiment has, for example, an image-holding member (hereinafter, may be referred to as “photoreceptor”), a charging unit that charges the surface of the image-holding member, a latent image-forming unit that forms a latent image (electrostatic latent image) on the surface of the image-holding member, a developing unit that develops the latent image formed on the surface of the image-holding member using a developer so as to form a toner image, a transferring unit that transfers the toner image formed on the surface of the image-holding member to a recording medium, and a fixing unit that fixes the toner image transferred to the recording medium so as to form a fixed image.

In the image-forming apparatus, for example, a portion including the developing unit may have a cartridge structure attachable to and detachable from the main body of the image-forming apparatus (process cartridge). The process cartridge is not particularly limited as long as the process cartridge has the transfer member according to the exemplary embodiment. The process cartridge has, for example, the transfer member according to the exemplary embodiment and the developing unit that develops the latent image formed on the image-holding member using a liquid developer so as to form a toner image, and is detachable from the image-forming apparatus.

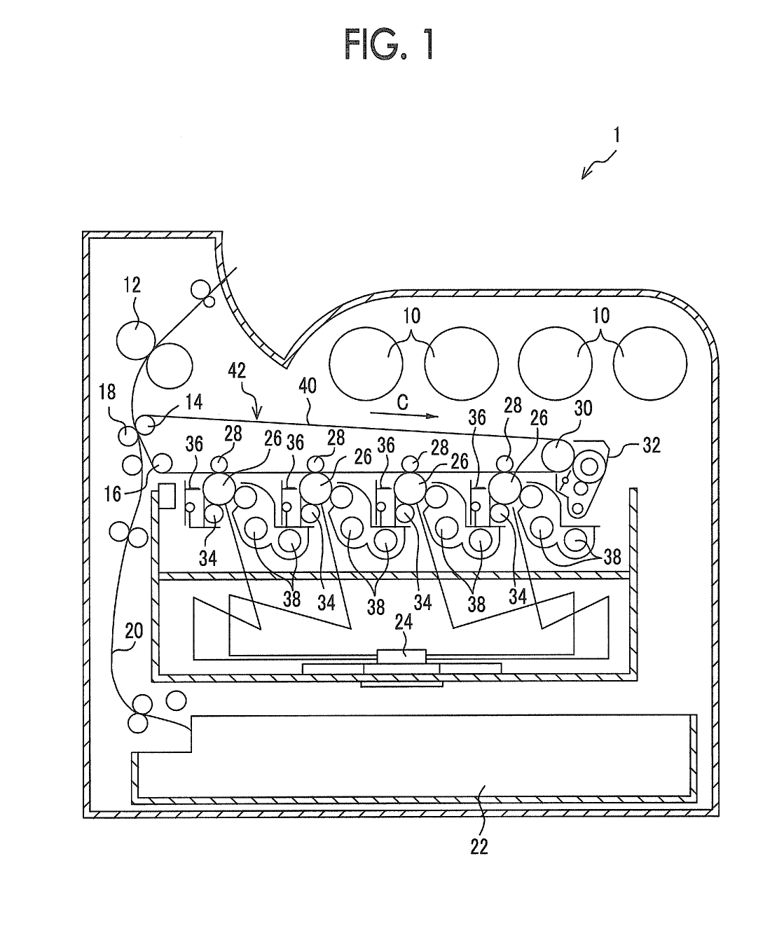

The image-forming apparatus according to the exemplary embodiment has the transfer member. FIG. 1 is a schematic configuration view explaining the main portions of a tandem-type image-forming apparatus having the transfer member as at least one of an intermediate transfer belt and a transfer roll.

Specifically, an image-forming apparatus 1 is configured to include a photoreceptor 26 (electrostatic latent image-forming member), a charging roll 34 that charges the surface of the photoreceptor 26, a laser generating apparatus 24 (electrostatic latent image-forming unit) that exposes the surface of the photoreceptor 26 so as to form an electrostatic latent image, a developing machine 38 (developing unit) that develops the latent image formed on the surface of the photoreceptor 26 using a developer so as to form a toner image, an intermediate transfer belt 40 (intermediate transfer member) to which the toner image formed by the developing machine 38 is transferred from the photoreceptor 26, a primary transfer roll 28 (primary transfer unit) that transfers the toner image to the intermediate transfer belt 40, a photoreceptor-cleaning member 36 that removes toner, debris, and the like attached to the photoreceptor 26, a secondary transfer roll 18 (secondary transfer unit) that transfers the toner image on the intermediate transfer belt 40 to a recording medium, and a fixing apparatus 12 (fixing unit) that fixes the toner image on the recording medium. The photoreceptor 26 and the primary transfer roll 28 may be disposed right above the photoreceptor 26 as shown in FIG. 1, or may be disposed at a location deviating from right above the photoreceptor 26.

Furthermore, the configuration of the image-forming apparatus 1 shown in FIG. 1 will be described in detail. In the image-forming apparatus 1, the charging roll 34, the developing machine 38, the primary transfer roll 28 disposed through the intermediate transfer belt 40, and the photoreceptor-cleaning member 36 are disposed counterclockwise around the photoreceptor 26, and one set of the above forms a developing unit that corresponds to one color. In addition, a toner cartridge 10 that replenishes the developer to the developing machine 38 is provided for each of the developing units, and the laser-generating apparatus that irradiates laser light in accordance with image information on the surface of the photoreceptor 26 that is located on the downstream side of the charging roll 34 (the rotation direction of the photoreceptor 26) and the upstream side of the developing machine 38 is provided for the photoreceptor 26 of each of the developing units.

Four developing units corresponding to four colors (for example, cyan, magenta, yellow, and black) are disposed in a series in the horizontal direction in the image-forming apparatus 1, and the intermediate transfer belt 40 is provided so as to penetrate the transfer areas of the photoreceptors 26 and the primary transfer rolls 28 of four developing units. The intermediate transfer belt 40 is stretched through a supporting roll 14, a supporting roll 16, and a driving roll 30 which are provided counterclockwise in this order on the inner surface side of the intermediate transfer belt so as to form a belt stretching apparatus 42. Meanwhile, four primary transfer rolls are located on the downstream side of the supporting roll 14 (the rotation direction of the intermediate transfer belt 40) and on the upstream side of the supporting roll 16. In addition, a transfer-cleaning member 32 that cleans the outer circumferential surface of the intermediate transfer belt 40 is provided on the opposite side of the driving roll 30 through the intermediate transfer belt 40 so as to come into contact with the driving roll 30.

In addition, the secondary transfer roll 18 for transferring a toner image formed on the outer circumferential surface of the intermediate transfer belt 40 to the surface of the recording medium transported from a paper feeding portion 22 through a paper path 20 is provided on the opposite side of the supporting roll 14 through the intermediate transfer belt 40 so as to come into contact with the supporting roll 14.

In addition, the paper feeding portion 22 that houses a recording medium is provided at the bottom of the image-forming apparatus 1, and a recording medium is supplied from the paper feeding portion 22 through the paper path 20 so as to pass through the contact portion between the supporting roll 14 that composes the secondary transfer portion and the secondary transfer roll 18. The recording medium that has passed through the contact portion is furthermore transported by a transporting unit, not shown, so as to be inserted through the contact portion of the fixing apparatus 12, and, finally, ejected outside the image-forming apparatus 1.

Next, a method of forming an image in which the image-forming apparatus 1 shown in FIG. 1 is used will be described. A toner image is formed at each of the developing units. After the surface of the photoreceptor 26 rotating in counterclockwise direction is charged by the charging roll 34, a latent image (electrostatic latent image) is formed on the surface of the photoreceptor 26 charged by the laser-generating apparatus 24 (exposure apparatus), then, the latent image is developed using a developer supplied from the developing machine 38 so as to form a toner image, and the toner image delivered to the contact portion between the primary transfer roll 28 and the photoreceptor 26 is transferred to the outer circumferential surface of the intermediate transfer belt 40 that rotates in the arrow C direction. Meanwhile, toner, debris, and the like attached to the surface of the photoreceptor 26 are cleaned by the photoreceptor-cleaning member 36 so that the photoreceptor 26 that has transferred the toner image is made to be ready for formation of the next toner image.

The toner images developed by the respective developing units of the respective colors are delivered to the secondary transfer portion in a state in which the toner images are sequentially overlapped on the outer circumferential surface of the intermediate transfer belt 40 in accordance with image information, and transferred to the surface of the recording medium transported from the paper feeding portion 22 through the paper path 20 by the secondary transfer roll 18. Furthermore, when passing through the contact portion of the fixing apparatus 12, the recording medium to which the toner images are transferred is pressurized and heated for fixing, an image is formed on the surface of the recording medium, and then the recording medium is ejected outside the image-forming apparatus.

### EXAMPLES

Hereinafter, the invention will be more specifically described in detail using examples and comparative examples, but the invention is not limited to the following examples. Meanwhile, in the following, “parts” and “%” are based on weight unless otherwise described.

### Example 1

### Synthesis of a Hydroxyl Group-Containing Acrylic Resin prepolymer A1

A monomer liquid mixture including 130.1 parts by weight of hydroxyethyl methacrylate (HEMA) which is a monomer including a short side chain hydroxyl group having 3 carbon atoms, 71.1 parts by weight of butyl methacrylate (BMA) which is a monomer having no hydroxyl group, 62.5 parts by weight of SILAPLANE FM0711 (manufactured by Chisso Corporation) which is a monomer that has no hydroxyl group and includes a siloxane bond, and 4.8 parts by weight of a polymerization initiator (benzoyl peroxide, BPO) is put into a dropping funnel, the monomer liquid mixture is added dropwise over 3 hours while being stirred into 100 parts by weight of methyl ethyl ketone that is heated to 80° C. under a nitrogen reflux, thereby performing polymerization. Furthermore, a liquid including 50 parts by weight of methyl ethyl ketone and 2 parts by weight of azoisobutyronitrile (AIBN) is added dropwise over 1 hour, and, furthermore, the resultant is stirred for 1 hour, thereby completing the reaction. Meanwhile, during the reaction, the liquid is continuously stirred while being maintained at 80° C. The concentration is adjusted to 40% by weight by concentrating the reaction liquid, and a hydroxyl group-containing acrylic resin prepolymer A1 having the hydroxyl group-containing acrylic resin prepolymer dissolved in a solvent is synthesized.

Meanwhile, for the monomer including a siloxane bond, R¹ in the formula (A) is a butyl group, R² is a butyl group, R³ is a propyl methacrylate group, and the number average molecular weight is 1,000.

<Preparation of Composition 1>

The following C1 liquid and B1 liquid (polyol) are added to the following A1 liquid so as to obtain a composition 1.
A1 liquid (a methyl ethyl ketone solution of the hydroxyl group-containing acrylic resin prepolymer A1, the concentration of the hydroxyl group-containing acrylic resin prepolymer A1: 40% by weight, hydroxyl value: 200): 100 parts by weight
B1 liquid (polyol, manufactured by Daicel Chemical Industries, Ltd., PLACCEL 208, hydroxyl value: 138): 118.7 parts by weight
C1 liquid (isocyanate, manufactured by Asahi Kasei Chemicals Corporation, product number: DURANATE TPA100, compound name: a polyisocyanurate member of hexamethylene diisocyanate): 26.0 parts by weight

<Formation of Resin Layer Sample A1>

After the composition 1 is defoamed for 10 minutes under depressurization, the composition 1 is coated (cast) on a 90 μm-thick polyimide film, and cured at 85° C. for 1 hour and at 160° C. for 60 minutes, thereby obtaining a 40 μm-thick resin layer sample A1. The total mole number of hydroxyl groups included in the acrylic resin is 0.143 mole (A), the molar amount of hydroxyl groups included in the polyol is 0.285 mole (B), and the ratio (B/A) is 2.

<Preparation of Conducting Agent Dispersion Liquid A1>

Acicular TiO₂ (short radius: 0.1 μm, long radius: 1.7 μm, aspect ratio: 17, volume resistivity: 1×10⁵Ω/□) is used as a conducting agent. Zirconia beads with (D2 mm are packed in a 110 cc sample bottle, and 54 g of a dispersion liquid is added for dispersion, thereby preparing a conducting agent dispersion liquid A1.

<Formation of Image Transfer Member A1>

The conducting agent dispersion liquid is added to the composition 1 at 40% by weight (13% by volume), the resulting solution is coated on a polyimide belt, and dried at 80° C. and 180° C. in a drying machine, thereby obtaining a 40 μm-thick image transfer member A1.

### Example 2

### Preparation of Conducting Agent Dispersion Liquid A2

A conducting agent dispersion liquid A2 is prepared in the same manner as in Example 1 except that TiO₂ (primary particle diameter: 30 nm, volume resistivity: 1×10⁵Ω/□) having a structural constitution is used instead of the acicular TiO₂ as the conducting agent.

<Formation of Image Transfer Member A2>

The conducting agent dispersion liquid A2 is added to the composition 1 at 60% by weight (27% by volume), the resulting solution is coated on the polyimide belt, and dried at 80° C. and 180° C. in a drying machine, thereby obtaining a 40 μm-thick image transfer member A2.

### Example 3

### Synthesis of Hydroxyl Group-Containing Acrylic Resin Prepolymer A3

A monomer liquid mixture including 130.1 parts by weight of hydroxyethyl methacrylate (HEMA) which is a monomer including a short side chain hydroxyl group having 3 carbon atoms, 86.4 parts by weight of CHEMINOX FAMAC6 (manufactured by Unimatec Co., Ltd., compound name: 2-(perfluorohexyl)ethyl methacrylate), and 100 parts by weight of SILAPLANE FM0721 (manufactured by Chisso Corporation) which is a monomer that has no hydroxyl group and includes a siloxane bond, is put into a dropping funnel, the monomer liquid mixture is added dropwise over 3 hours while being stirred into 100 parts by weight of methyl ethyl ketone that is heated to 80° C. under a nitrogen reflux, thereby performing polymerization. Furthermore, a liquid including 50 parts by weight of methyl ethyl ketone and 2 parts by weight of AIBN is added dropwise over 1 hour, and, furthermore, the resultant is stirred over 1 hour, thereby completing the reaction. Meanwhile, during the reaction, the liquid is continuously stirred while being maintained at 80° C. The concentration is adjusted to 40% by weight by concentrating the reaction liquid, and a hydroxyl group-containing acrylic resin prepolymer A3 having the hydroxyl group-containing acrylic resin prepolymer dissolved in a solvent is synthesized.

The content ratio (molar ratio) of long side chain hydroxyl groups to short side chain hydroxyl group in the obtained hydroxyl group-containing acrylic resin prepolymer A3, the proportion of side chains including a fluorine atom to all side chains in the hydroxyl group-containing acrylic resin, and the proportion of monomers including a siloxane bond to all monomers that are used for synthesis of the hydroxyl group-containing acrylic resin are shown in Table 1.

<Preparation of Composition 3>

A composition 3 is obtained in the same manner as for the composition 1 except that the following A3 liquid is used instead of the above A1 liquid, and the added amounts of the B1 liquid and C1 liquid are set as follows.
A3 liquid (a methyl ethyl ketone solution of the hydroxyl group-containing acrylic resin prepolymer A3, the concentration of the hydroxyl group-containing acrylic resin prepolymer A3: 40% by weight, hydroxyl value: 215): 100 parts by weight
B1 liquid (polyol, manufactured by Daicel Chemical Industries, Ltd., PLACCEL 208, hydroxyl value: 138): 31.7 parts by weight
C1 liquid (isocyanate, manufactured by Asahi Kasei Chemicals Corporation, product number: DURANATE TPA100, compound name: a polyisocyanurate member of hexamethylene diisocyanate): 53 parts by weight

<Formation of Resin Layer Sample A3>

A 40 μm-thick resin layer sample A3 is obtained in the same manner as for the resin layer sample A1 except that the composition 3 is used instead of the composition 1. The total molar amount of hydroxyl groups included in the acrylic resin is 0.153 mole (A), the total molar amount of hydroxyl groups included in the polyol is 0.0765 mole (B), and the ratio (B/A) is 0.5.

<Formation of Image Transfer Member A3>

The conducting agent dispersion liquid Aα is added to the composition 3 at 40% by weight (13% by volume), the resulting solution is coated on a polyimide belt, and dried at 80° C. and 180° C. in a drying machine, thereby obtaining a 40 μm-thick image transfer member A3.

### Example 4

### Synthesis of Hydroxyl Group-Containing Acrylic Resin Prepolymer A4

A hydroxyl group-containing acrylic resin prepolymer A4 is synthesized in the same manner as for the synthesis of the hydroxyl group-containing acrylic resin prepolymer A1 except that the added amount of hydroxyethyl methacrylate is set to 32.5 parts by weight, and PLACCEL FM2 (manufactured by Daicel Chemical Industries, Ltd., compound name: lactone-modified methacrylate) which is a monomer including long side chain hydroxyl groups having 14 carbon atoms is added at 260 parts by weight.

The content ratio (molar ratio) of long side chain hydroxyl groups to short side chain hydroxyl group in the obtained hydroxyl group-containing acrylic resin prepolymer A4, and the proportion of monomers including a siloxane bond to all monomers that are used for synthesis of the hydroxyl group-containing acrylic resin are shown in Table 1.

<Preparation of Composition 4>

A composition 4 is obtained in the same manner as for the composition 1 except that the following A4 liquid is used instead of the above A1 liquid, and the added amount of the C1 liquid is set as follows.
A4 liquid (a methyl ethyl ketone solution of the hydroxyl group-containing acrylic resin prepolymer A4, the concentration of the hydroxyl group-containing acrylic resin prepolymer A4: 40% by weight, hydroxyl value: 150): 100 parts by weight
B1 liquid (polyol, manufactured by Daicel Chemical Industries, Ltd., PLACCEL 208, hydroxyl value: 138): 118.7 parts by weight
C1 liquid (isocyanate, manufactured by Asahi Kasei Chemicals Corporation, product number: DURANATE TPA100, compound name: a polyisocyanurate member of hexamethylene diisocyanate): 23 parts by weight

<Formation of Resin Layer Sample A4>

A 40 μm-thick resin layer sample A4 is obtained in the same manner as for the resin layer sample A1 except that the composition 4 is used instead of the composition 1. The total molar amount of hydroxyl groups included in the acrylic resin is 0.036 mole (A), the total molar amount of hydroxyl groups included in the polyol is 0.285 mole (B), and the ratio (B/A) is 7.9.

<Formation of Image Transfer Member A4>

A 40 μm-thick image transfer member A4 is obtained in the same manner as in Example 1 except that the composition 4 is used instead of the composition 1.

### Example 5

### Synthesis of Acrylic Resin Prepolymer A5

A hydroxyl group-containing acrylic resin prepolymer A5 is synthesized in the same manner as for the synthesis of the hydroxyl group-containing acrylic resin prepolymer A1 except that the added amount of hydroxyethyl methacrylate is set to 32.5 parts by weight, and the added amount of PLACCEL FM2 is set to 268 parts by weight.

The content ratio (molar ratio) of long side chain hydroxyl groups to short side chain hydroxyl group in the obtained hydroxyl group-containing acrylic resin prepolymer A5, and the proportion of monomers including a siloxane bond to all monomers that are used for synthesis of the hydroxyl group-containing acrylic resin are shown in Table 1.

<Preparation of Composition 5>

A composition 5 is obtained in the same manner as for the composition 1 except that the following A5 liquid is used instead of the above A1 liquid, and the added amount of the C1 liquid is set as follows.
A5 liquid (a methyl ethyl ketone solution of the hydroxyl group-containing acrylic resin prepolymer A5, the concentration of the hydroxyl group-containing acrylic resin prepolymer A5: 40% by weight, hydroxyl value: 148): 100 parts by weight
B1 liquid (polyol, manufactured by Daicel Chemical Industries, Ltd., PLACCEL 208, hydroxyl value: 138): 118.7 parts by weight
C1 liquid (isocyanate, manufactured by Asahi Kasei Chemicals Corporation, product number: DURANATE TPA100, compound name: a polyisocyanurate member of hexamethylene diisocyanate): 20 parts by weight

<Formation of Resin Layer Sample A5>

A 40.1 μm-thick resin layer sample A5 is obtained in the same manner as for the resin layer sample A1 except that the composition 5 is used instead of the composition 1. The total molar amount of hydroxyl groups included in the acrylic resin is 0.035 mole (A), the total molar amount of hydroxyl groups included in the polyol is 0.285 mole (B), and the ratio (B/A) is 8.1.

<Formation of Image Transfer Member A5>

A 40 μm-thick image transfer member A5 is obtained in the same manner as in Example 1 except that the composition 5 is used instead of the composition 1.

### Example 6

### Preparation of Conducting Agent Dispersion Liquid A6

A conducting agent dispersion liquid A6 is prepared in the same manner as in Example 1 except that acicular TiO₂ (short radius: 0.1 μm, long radius: 1.0 μm, aspect ratio: 10, volume resistivity: 1×10⁶ Ω·cm) is used instead of the acicular TiO₂ (aspect ratio: 17) as the conducting agent.

<Formation of Image Transfer Member A6>

The conducting agent dispersion liquid A6 is added to the composition 1 at 40% by weight (13% by volume), the resulting solution is coated on the polyimide belt, and dried at 80° C. and 180° C. in a drying machine, thereby obtaining a 40 μm-thick image transfer member A6.

### Example 7

### Synthesis of acrylic polymer 7

An acryl polymer 7 is synthesized in the same manner except that SILAPLANE FM0711 of Example 1 (manufactured by Chisso Corporation) which is a monomer that has no hydroxyl group and includes a siloxane bond is removed.

<Preparation of Composition 7>

A composition 7 is obtained by the same method except that the 31 liquid and the C1 liquid are not used in Example 1.

<Formation of Resin Layer Sample A7>

A 40 μm-thick resin layer sample A7 is obtained in the same manner as for the resin layer sample A1 except that the composition 7 is used instead of the composition 1.

<Formation of Image Transfer Member A7>

A 40 μm-thick image transfer member A7 is obtained in the same manner as in Example 1 except that the composition 7 is used instead of the composition 1.

### Example 8

### Preparation of Conducting Agent Dispersion Liquid A8

A conducting agent dispersion liquid A8 is prepared in the same manner as in Example 1 except that the amount of acicular TiO₂ is set to 30 parts by weight (10% by volume).

<Formation of Image Transfer Member A8>

The conducting agent dispersion liquid A8 is added to the composition 1 at 40% by weight (13% by volume), the resulting solution is coated on the polyimide belt, and dried at 80° C. and 180° C. in a drying machine, thereby obtaining a 40 μm-thick image transfer member A8.

### Example 9

### Preparation of Conducting Agent Dispersion Liquid A9

A conducting agent dispersion liquid A9 is prepared in the same manner as in Example 1 except that the amount of acicular TiO₂ is set to 123 parts by weight (40% by volume).

<Formation of Image Transfer Member A9>

The conducting agent dispersion liquid A9 is added to the composition 1 at 40% by weight (13% by volume), the resulting solution is coated on the polyimide belt, and dried at 80° C. and 180° C. in a drying machine, thereby obtaining a 40 μm-thick image transfer member A9.

### Example 10

### Formation of Image Transfer Member A10

The conducting agent dispersion liquid A1 is added to the composition 1 at 5% by weight (1.6% by volume), the resulting solution is coated on the polyimide belt, and dried at 80° C. and 180° C. in a drying machine, thereby obtaining a 40 μm-thick image transfer member A10.

### Example 11

### Preparation of Conducting Agent Dispersion Liquid A11

A conducting agent dispersion liquid A11 is prepared in the same manner as in Example 1 except that the amount of acicular TiO₂ is set to 138.5 parts by weight (45% by volume).

<Formation of Image Transfer Member A11>

The conducting agent dispersion liquid A11 is added to the composition 1 at 40% by weight (13% by volume), the resulting solution is coated on the polyimide belt, and dried at 80° C. and 180° C. in a drying machine, thereby obtaining a 40 μm-thick image transfer member A11.

### Example 12

### Preparation of Composition 12

A composition 12 is obtained in the same manner as for the composition 1 except that the B1 liquid (polyol, manufactured by Daicel Chemical Industries, Ltd., PLACCEL 208, hydroxyl value: 138) is set to 5.94 parts by weight.

<Formation of Resin Layer Sample A12>

A 40 μm-thick resin layer sample A12 is obtained in the same manner as for the resin layer sample A1 except that the composition 12 is used instead of the composition 1. The ratio (B/A) between the total molar amount (A) of hydroxyl groups included in the acrylic resin and the total molar amount (B) of hydroxyl groups included in the polyol is 0.1.

<Formation of Image Transfer Member A12>

A 40 μm-thick image transfer member A12 is obtained in the same manner as in Example 1 except that the composition 12 is used instead of the composition 1.

### Example 13

### Preparation of Composition 13

A composition 13 is obtained in the same manner as for the composition 1 except that the B1 liquid (polyol, manufactured by Daicel Chemical Industries, Ltd., PLACCEL 208, hydroxyl value: 138) is set to 593.5 parts by weight.

<Formation of Resin Layer Sample A13>

A 40 μm-thick resin layer sample A13 is obtained in the same manner as for the resin layer sample A1 except that the composition 13 is used instead of the composition 1. The ratio (B/A) between the total molar amount (A) of hydroxyl groups included in the acrylic resin and the total molar amount (B) of hydroxyl groups included in the polyol is 10.1.

<Formation of Image Transfer Member A13>

A 40 μm-thick image transfer member A13 is obtained in the same manner as in Example 1 except that the composition 13 is used instead of the composition 1.

### Example 14

### Preparation of Composition 14

A composition 14 is obtained in the same manner as for the composition 1 except that the B1 liquid (polyol, manufactured by Daicel Chemical Industries, Ltd., PLACCEL 208, hydroxyl value: 138) is set to 5.9 parts by weight.

<Formation of Resin Layer Sample A14>

A 40 μm-thick resin layer sample A14 is obtained in the same manner as for the resin layer sample A1 except that the composition 14 is used instead of the composition 1. The ratio (B/A) between the total molar amount (A) of hydroxyl groups included in the urethane resin and the total molar amount (B) of hydroxyl groups included in the polyol is 0.099.

<Formation of Image Transfer Member A14>

A 40 μm-thick image transfer member A14 is obtained in the same manner as in Example 1 except that the composition 14 is used instead of the composition 1.

### Example 15

### Preparation of Composition 15

A composition 15 is obtained in the same manner as for the composition 1 except that the B1 liquid (polyol, manufactured by Daicel Chemical Industries, Ltd., PLACCEL 208, hydroxyl value: 138) is set to 620 parts by weight.

<Formation of Resin Layer Sample A15>

A 40 μm-thick resin layer sample A15 is obtained in the same manner as for the resin layer sample A1 except that the composition 15 is used instead of the composition 1. The ratio (B/A) between the total molar amount (A) of hydroxyl groups included in the urethane resin and the total molar amount (B) of hydroxyl groups included in the polyol is 10.4.

<Formation of Image Transfer Member A15>

A 40 μm-thick image transfer member A15 is obtained in the same manner as in Example 1 except that the composition 15 is used instead of the composition 1.

### Example 16

### Synthesis of Hydroxyl Group-Containing Acrylic Resin Prepolymer A16

A monomer liquid mixture including 130.1 parts by weight of HEMA which is a monomer including a short side chain hydroxyl group having 3 carbon atoms, 28.5 parts by weight of butyl methacrylate (BMA) which is a monomer having no hydroxyl group, and 4.5 parts by weight of a polymerization initiator (benzoyl peroxide, BPO) is put into a dropping funnel, the monomer liquid mixture is added dropwise over 3 hours while being stirred into 100 parts by weight of methyl ethyl ketone that is heated to 80° C. under a nitrogen reflux, thereby performing polymerization. Furthermore, a liquid including 50 parts by weight of methyl ethyl ketone and 2 parts by weight of azoisobutyronitrile (AIBN) is added dropwise over 1 hour, and, furthermore, the resultant is stirred for 1 hour, thereby completing the reaction. Meanwhile, during the reaction, the liquid is continuously stirred while being maintained at 80° C. The concentration is adjusted to 40% by weight by concentrating the reaction liquid, and a hydroxyl group-containing acrylic resin prepolymer A16 having the hydroxyl group-containing acrylic resin prepolymer dissolved in a solvent is synthesized.

<Preparation of Composition 16>

A composition 16 is obtained in the same manner as for the composition 1 except that the following A16 liquid is used instead of the above A1 liquid, and the added amount of the C1 liquid is set as follows.
A16 liquid (a methyl ethyl ketone solution of the hydroxyl group-containing acrylic resin prepolymer A16, the concentration of the hydroxyl group-containing acrylic resin prepolymer A16: 40% by weight): 100 parts by weight
B1 liquid (polyol, manufactured by Daicel Chemical Industries, Ltd., PLACCEL 208, hydroxyl value: 138): 118.7 parts by weight
C1 liquid (isocyanate, manufactured by Asahi Kasei Chemicals Corporation, product number: DURANATE TPA100, compound name: a polyisocyanurate of hexamethylene diisocyanate): 14 parts by weight

<Formation of Resin Layer Sample A16>

A 40 μm-thick resin layer sample A16 is obtained in the same manner as for the resin layer sample A1 except that the composition 16 is used instead of the composition 1. The ratio (B/A) between the total molar amount (A) of hydroxyl groups included in the acrylic resin and the total molar amount (B) of hydroxyl groups included in the polyol is 2.

<Formation of Image Transfer Member A16>

The conducting agent dispersion liquid A1 is added to the composition 16 at 20% by weight (6.5% by volume), the resulting solution is coated on a polyimide belt, and dried at 80° C. and 180° C. in a drying machine, thereby obtaining a 40 μm-thick image transfer member A16.

### Example 17

### Preparation of Conducting Agent Dispersion Liquid A17

A conducting agent dispersion liquid A17 is prepared in the same manner as in Example 1 except that acicular SnO₂ (short radius: 0.1 μm, long radius: 1.7 μm, aspect ratio: 17, volume resistivity: 2 Ω·cm) is used instead of acicular TiO₂ as a conducting agent.

<Formation of Image Transfer Member A17>

The conducting agent dispersion liquid A17 is added to the composition 1 at 20% by weight (10% by volume), the resulting solution is coated on a polyimide belt, and dried at 80° C. and 180° C. in a drying machine, thereby obtaining a 40 μm-thick image transfer member A17.

### Example 18

### Preparation of Conducting Agent Dispersion Liquid A18

A conducting agent dispersion liquid A18 is prepared in the same manner as in Example 1 except that SnO₂ having a structural constitution (primary particle diameter: 300 nm, volume resistivity: 7 Ω·cm) is used instead of acicular TiO₂ as a conducting agent.

<Formation of Image Transfer Member A18>

The conducting agent dispersion liquid A18 is added to the composition 1 at 50% by weight (25% by volume), the resulting solution is coated on a polyimide belt, and dried at 80° C. and 180° C. in a drying machine, thereby obtaining a 40 μm-thick image transfer member A18.

### Comparative Example 1

### Preparation of Conducting Agent Dispersion Liquid B1

A conducting agent dispersion liquid B1 is prepared in the same manner as in Example 1 except that carbon black (manufactured by Evonic Degussa GmbH, Special Black 4 (DBP oil absorption: 280 g/100 g, volume average particle diameter: 25 nm, volatile portion: 14%, volume resistivity: 1×10⁻¹ Ω·cm) is used instead of acicular TiO₂ as a conducting agent.

<Formation of Image Transfer Member B1>

The conducting agent dispersion liquid B1 is added to the composition 1 at 20% by weight (13% by volume), the resulting solution is coated on a polyimide belt, and dried at 80° C. and 180° C. in a drying machine, thereby obtaining a 40 μm-thick image transfer member B1.

### Comparative Example 2

### Preparation of Conducting Agent Dispersion Liquid B2

A conducting agent dispersion liquid B2 is prepared in the same manner as in Example 1 except that granular TiO₂ (primary particle diameter: 60 nm, volume resistivity: 3×10⁶ Ω·cm) is used instead of acicular TiO₂ as a conducting agent.

<Formation of Image Transfer Member B2>

The conducting agent dispersion liquid B2 is added to the composition 1 at 60% by weight (27% by volume), the resulting solution is coated on a polyimide belt, and dried at 80° C. and 180° C. in a drying machine, thereby obtaining a 40 μm-thick image transfer member B2.

### Comparative Example 3

### Preparation of Conducting Agent Dispersion Liquid B3

A conducting agent dispersion liquid B3 is prepared in the same manner as in Example 1 except that acicular TiO₂ (short radius: 0.3 μm, long radius: 2 aspect ratio: 7, volume resistivity: 1×10⁶ Ω·cm) is used instead of acicular TiO₂ (aspect ratio: 17) as a conducting agent.

<Formation of Image Transfer Member B3>

The conducting agent dispersion liquid B3 is added to the composition 1 at 40% by weight (13% by volume), the resulting solution is coated on a polyimide belt, and dried at 80° C. and 180° C. in a drying machine, thereby obtaining a 40 km-thick image transfer member B3.

[Evaluation of Image Transfer Member]

For the resin layer samples obtained in the above examples and comparative examples, the return rates are measured by the following method. The results are shown in Table 1.

(Return Rate)

A FISCHERSCOPE HM2000 (manufactured by Fischer Instruments K.K.) is used as a measurement apparatus, the obtained sample resin layer is fixed to a glass slide with an adhesive, and set in the measurement apparatus. A load is applied to the sample resin layer up to 0.5 mN at room temperature (23° C.) for 15 seconds, and held at 0.5 mN for 5 seconds. The maximum displacement at this time is represented as (h1). After that, the load is reduced up to 0.005 mN for 15 seconds, and the displacement when the load is held at 0.005 mN for 1 minute is represented as (h2), thereby evaluating the return rate (%) “[(h1−h2)/h1]×100(%).”

(Surface Roughness)

For the resin layer samples obtained in the above examples and comparative examples, the surface roughness of the resin layer is visually evaluated to evaluate the film quality. The evaluation standards are as follows, and the results are shown in Table 1.

A: no rough surface

B: partially rough surface

C: entirely rough surface

(Surface Resistivity)

For the image transfer member, the surface resistivity is preferably in a range of from 10¹⁰Ω/□ to 10¹²Ω/□ under an environment of 10° C. and 15% RH. The surface resistivity is measured using an ADVANTEST R8340A ULTRA HIGH RESISTANCE METER and a UR probe of Mitsubishi Chemical Analytech Co., Ltd. as the probe.

(Resistance Control Stability)

The maintainability of the resistivity is evaluated by idly spinning the image transfer member at −3.9 kV and a running time of 24 hours under an environment of 10° C. and 15% RH using a discharge degradation pinch which is a reformed image-forming apparatus (manufactured by Fuji Xerox Co., Ltd., A-color 930), and measuring the surface resistivity before and after the discharge degradation test. The evaluation standards are as follows, and the results are shown in Table 1.

A: no resistivity change

B: 1 or more orders of magnitude of surface resistance change

C: 2 or more orders of magnitude of surface resistance change

(Surface Mold-Releasing Properties)

The mold-releasing properties of the resin layer samples obtained above are evaluated by the following method. A polyimide film on which the above-obtained resin layer sample is formed is attached to the surface of a fixing roll, and 10,000 sheets of paper are put through a fixing machine (the same fixing machine as above from which peels are removed). The mold-releasing properties are evaluated to be A when 10,000 sheets of paper may be put through the fixing machine, and evaluated to be C when 10,000 sheets of paper may not be put through the fixing machine without peels.

(Working on Embossed Paper)

Black solid images are printed on lezak or crocodile paper (125 gsm) using an image-forming apparatus (manufactured by Fuji Xerox Co., Ltd., A-color 930), and working on embossed paper is evaluated using the image concentration. The evaluation standards are as follows, and the results are shown in Table 1.

A: 1.0 or more in image concentration

B: 0.8 or less in image concentration

C: 0.6 or less in image concentration

TABLE 1

| | Acrylic resin prepolymer | | | | | | |
|---|---|---|---|---|---|---|---|
| | | Ratio of | Proportion of | Proportion of | | | |
| | | long side | side chain | monomers | | | |
| | | chain/short | including | including | | Conducting material | |
| | | side | fluorine atoms | siloxane bond | | | Amount |
| | Type | chain | (mol %) | (weight %) | B/A | Type | (vol %) |
| Example 1 | A1 | 0 | 0 | 4 | 2 | TiO₂ (aspect | 13 |
| | | | | | | ratio 17) | |
| Example 2 | A1 | 0 | 0 | 4 | 2 | TiO₂ (structural | 27 |
| | | | | | | constitution) | |
| Example 3 | A3 | 0 | 15.4 | 7.7 | 2 | TiO₂ (aspect | 13 |
| | | | | | | ratio 17) | |
| Example 4 | A4 | 0.29 | 0 | 6.4 | 7.9 | TiO₂ (aspect | 13 |
| | | | | | | ratio 17) | |
| Example 5 | A5 | 0.33 | 0 | 4 | 8.1 | TiO₂ (aspect | 13 |
| | | | | | | ratio 17) | |
| Example 6 | A1 | 0 | 0 | 4 | 2 | TiO₂ (aspect | 13 |
| | | | | | | ratio 10) | |
| Example 7 | A7 | 0 | 0 | 0 | 0 | TiO₂ (aspect | 13 |
| | | | | | | ratio 10) | |
| Example 8 | A1 | 0 | 0 | 4 | 2 | TiO₂ (aspect | 10 |
| | | | | | | ratio 17) | |
| Example 9 | A7 | 0 | 0 | 4 | 2 | TiO₂ (aspect | 40 |
| | | | | | | ratio 17) | |
| Example 10 | A1 | 0 | 0 | 4 | 2 | TiO₂ (aspect | 1.6 |
| | | | | | | ratio 17) | |
| Example 11 | A1 | 0 | 0 | 4 | 2 | TiO₂ (aspect | 45 |
| | | | | | | ratio 17) | |
| Example 12 | A1 | 0 | 0 | 4 | 0.1 | TiO₂ (aspect | 13 |
| | | | | | | ratio 17) | |
| Example 13 | A1 | 0 | 0 | 4 | 10 | TiO₂ (aspect | 13 |
| | | | | | | ratio 17) | |
| Example 14 | A1 | 0 | 0 | 4 | 0.09 | TiO₂ (aspect | 13 |
| | | | | | | ratio 17) | |
| Example 15 | A1 | 0 | 0 | 4 | 10.4 | TiO₂ (aspect | 13 |
| | | | | | | ratio 17) | |
| Example 16 | A16 | 0 | 0 | 0 | 2 | TiO₂ (aspect | 13 |
| | | | | | | ratio 17) | |
| Example 17 | A1 | 0 | 0 | 4 | 2 | SnO₂ (aspect | 10 |
| | | | | | | ratio 17) | |
| Example 18 | A1 | 0 | 0 | 4 | 2 | SnO₂ (structural | 25 |
| | | | | | | constitution) | |
| Comparative | A1 | 0 | 0 | 4 | 2 | CB | 13 |
| Example 1 | | | | | | | |
| Comparative | A1 | 0 | 0 | 4 | 2 | Granular TiO₂ | 27 |
| Example 2 | | | | | | | |
| Comparative | A1 | 0 | 0 | 4 | 2 | TiO₂ (aspect | 13 |
| Example 3 | | | | | | ratio 7) | |

| | Evaluation of resin | | | | | |
|---|---|---|---|---|---|---|
| | layer sample | | Evaluation as transfer member | | | |
| | Return | | surface | Resistance | Surface | Working on |
| | rate | Surface | resistivity | control | mold-releasing | embossed |
| | (%) | roughness | (Ω/□) | stability | properties | paper |
| Example 1 | 93 | A | 6.1 × 10¹⁰ | A | A | A |
| Example 2 | 93 | A | 1.7 × 10¹¹ | A | A | A |
| Example 3 | 95 | A | 5.5 × 10¹⁰ | A | A | A |
| Example 4 | 90 | A | 1.8 × 10¹⁰ | A | A | A |
| Example 5 | 90 | A | 2.5 × 10¹⁰ | B | A | B |
| Example 6 | 93 | A | 2.0 × 10¹¹ | A | A | A |
| Example 7 | 50 | A | 2.5 × 10¹⁰ | A | A | B |
| Example 8 | 93 | A | 1.4 × 10¹² | A | A | A |
| Example 9 | 85 | A | 2.5 × 10⁹ | A | A | A |
| Example 10 | 93 | A | 1.0 × 10¹⁶ | B | A | B |
| Example 11 | 70 | A | 2.5 × 10⁹ | A | A | B |
| Example 12 | 85 | A | 2.5 × 10¹⁰ | A | A | A |
| Example 13 | 95 | A | 2.0 × 10¹⁰ | B | A | A |
| Example 14 | 75 | A | 1.8 × 10¹⁰ | A | A | B |
| Example 15 | 95 | B | 2.5 × 10¹⁰ | B | A | B |
| Example 16 | 90 | A | 3.2 × 10¹⁰ | A | B | A |
| Example 17 | 85 | A | 5.6 × 10¹¹ | B | A | A |
| Example 18 | 80 | A | 2.5 × 10¹¹ | B | A | B |
| Comparative | 80 | B | 2.5 × 10¹¹ | C | B | B |
| Example 1 | | | | | | |
| Comparative | 50 | B | 2.5 × 10¹⁴ | C | A | C |
| Example 2 | | | | | | |
| Comparative | 90 | A | 8.8 × 10¹³ | C | A | A |
| Example 3 | | | | | | |

As such, compared to Comparative Examples, the resistance control stability is excellent, and discharge degradation is suppressed in Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A conductive protective film including:
a resin and, as a conducting material, an inorganic metal oxide having a structural constitution or an inorganic metal oxide having an aspect ratio, which is a ratio between a short axis and a long axis, of approximately 10 or more.

2. The conductive protective film according to claim 1,
wherein a content of the inorganic metal oxide is in a range of from approximately 10% by volume to approximately 40% by volume with respect to the weight of the resin, and a surface resistivity of the conductive protective film is in a range of from approximately 10⁸Ω/□ to approximately 10¹⁴Ω/□.

3. The conductive protective film according to claim 1,
wherein the resin is a urethane resin that is formed by polymerization of: a hydroxyl group-containing acrylic resin in which a content ratio (molar ratio) of side chain hydroxyl groups having 10 or more carbon atoms to side chain hydroxyl group having less than 10 carbon atoms is approximately less than 1/3; a polyol having a plurality of hydroxyl groups in which the hydroxyl groups are coupled through a carbon chain having 6 or more carbon atoms; and an isocyanate, and a ratio (B/A) of a total molar amount (B) of the hydroxyl groups included in the polyol to a total molar amount (A) of the hydroxyl groups included in the acrylic resin is from approximately 0.1 to approximately 10.

4. The conductive protective film according to claim 2,
wherein the resin is a urethane resin that is formed by polymerization of: a hydroxyl group-containing acrylic resin in which a content ratio (molar ratio) of side chain hydroxyl groups having 10 or more carbon atoms to side chain hydroxyl group having less than 10 carbon atoms is approximately less than 1/3; a polyol having a plurality of hydroxyl groups in which the hydroxyl groups are coupled through a carbon chain having 6 or more carbon atoms; and an isocyanate, and a ratio (B/A) of a total molar amount (B) of the hydroxyl groups included in the polyol to a total molar amount (A) of the hydroxyl groups included in the acrylic resin is from approximately 0.1 to approximately 10.

5. The conductive protective film according to claim 1,
wherein the urethane resin includes at least one of a silicon atom and a fluorine atom.

6. The conductive protective film according to claim 2,
wherein the urethane resin includes at least one of a silicon atom and a fluorine atom.

7. A transfer member comprising the conductive protective film according to claim 1.

8. A process cartridge comprising the transfer member according to claim 7.

9. An image-forming apparatus comprising the transfer according to claim 7.
